(19) United States
(12) Patent Application Publication
(10) Pub. No.: US 2025/0259453 A1
(43) Pub. Date: Aug. 14, 2025

(54) INFORMATION PROCESSING DEVICE, INFORMATION PROCESSING METHOD, AND INFORMATION PROCESSING SYSTEM

(71) Applicant: SONY GROUP CORPORATION, TOKYO (JP)

(72) Inventor: KOJI NAGATA, TOKYO (JP)

(21) Appl. No.: 18/857,508

(22) PCT Filed: Apr. 6, 2023
(86) PCT No.: PCT/JP2023/014209

§ 371 Date: Oct. 17, 2024

(30) Foreign Application Priority Data
Apr. 25, 2022 (JP) 2022-071465

(51) Int. Cl. G06V 20/56; G06T 5/50; G06T 5/73; G06T 7/20; G06T 7/70; G06T 11/60

(52) U.S. Cl. CPC G06V 20/56; G06T 5/50; G06T 5/73; G06T 7/20; G06T 7/70; G06T 11/60; G06T 2207/20221; G06V 2201/07

(57) ABSTRACT

An information processing device includes a control unit that receives, at a first frequency, a first image generated by an imaging unit mounted on a mobile body and first time information at which the first image is generated; receives, at a second frequency higher than the first frequency, motion information regarding a motion of the mobile body generated by a sensor unit mounted on the mobile body and second time information at which the motion information is generated; and generates a second image based on the first image and the motion information.

### FIELD

The present invention relates to an information processing device, an information processing method, and an information processing system.

### BACKGROUND

In the related art, techniques related to a remote operation of a mobile body are known. For example, techniques of presenting an image captured by a camera mounted on the mobile body to a remote operator (hereinafter also referred to as an operator) who operates the mobile body from a distant location are known. For example, techniques for zooming in the image presented to the remote operator according to a motion of the mobile body are known.

### CITATION LIST

### Patent Literature

Patent Literature 1: WO 2021/002116 A

### SUMMARY

### Technical Problem

However, in the above-described technique of the related art, the image presented to the remote operator is merely zoomed in according to the motion of the mobile body, and usability in the remote operation of the mobile body may not be improved.

Accordingly, the present disclosure proposes an information processing device, an information processing method, and an information processing system capable of improving usability in a remote operation of a mobile body.

### Solution to Problem

To solve the above problem, an information processing device includes a control unit that receives, at a first frequency, a first image generated by an imaging unit mounted on a mobile body and first time information at which the first image is generated; receives, at a second frequency higher than the first frequency, motion information regarding a motion of the mobile body generated by a sensor unit mounted on the mobile body and second time information at which the motion information is generated; and generates a second image based on the first image and the motion information.

### BRIEF DESCRIPTION OF DRAWINGS

FIG. 1 is a diagram illustrating a configuration example of an information processing system according to an embodiment of the present disclosure.

FIG. 2 is a diagram illustrating a relationship between a predicted position of a vehicle and a view frustum according to the embodiment.

FIG. 3 is a diagram illustrating an example of object arrangement in a virtual space according to the embodiment.

FIG. 4 is a diagram illustrating an example of a first image generated by an imaging unit of a vehicle traveling straight forward and a second image viewed by a remote operator according to the embodiment.

FIG. 5 is a diagram illustrating a relationship between an acquisition frequency of the first image and an acquisition frequency of motion information according to the embodiment.

FIG. 6 is a diagram illustrating an example of object arrangement in the virtual space according to the embodiment.

FIG. 7 is a diagram illustrating an example of the first image generated by the imaging unit of the vehicle turning a curve and the second image viewed by the remote operator according to the embodiment.

FIG. 8 is a flowchart illustrating an information processing procedure by a remote operation device according to the embodiment.

FIG. 9 is a diagram illustrating countermeasures against vibration of a camera according to a modification of the embodiment.

FIG. 10 is a hardware configuration diagram illustrating an example of a computer that implements functions of an information processing device.

### DESCRIPTION OF EMBODIMENTS

Hereinafter, embodiments of the present disclosure will be described in detail with reference to the drawings. In each of the following embodiments, the same portions are denoted by the same reference numerals, and repeated description thereof will be omitted.

### EMBODIMENT

### 1. Introduction

In the related art, there is a problem that transmission of video information to a remote location is delayed in a remote operation of a mobile body. For example, due to the delay of the transmission of the video, finding of an obstacle may be late. The delay of the transmission of the video results in a problem that it is difficult to perform an operation in which a timing of a change in a direction during traveling is important. Further, to perform an accurate remote operation, a high-resolution video is required, but to transmit a high-resolution video in a situation where a transmission capacity is limited, it is necessary to relatively inhibit a transmission frequency (frame rate).

On the other hand, an information processing device according to the embodiment of the present disclosure generates an image in which an apparent delay time is invalidated by moving a view frustum to a position calculated from motion information of a mobile body among camera video and view frustums arranged in a virtual space. The information processing device displays the image in which the apparent delay time is invalidated for a remote operator. Accordingly, the information processing device can enable an operator to perform an operation without feeling uncomfortable or anxious and without perceiving delay of the video even when the video is delayed.

The information processing device acquires the motion information of the mobile body at a frequency higher than a frequency at which the camera video is acquired. Accordingly, the information processing device can complement the video even between frames of the camera video, and thus a problem due to a low frame rate can be solved at the same time. In actual communication, since a communication rate and communication delay are always changed, a frame interval of the camera video is also always changed. The information processing device can take flexible countermeasures against such change in the frame interval of the camera video, and can display an image with reduced discomfort even if the camera video is suddenly delayed or is lacking.

Accordingly, the information processing device can improve usability in a remote operation of a mobile body.

### 2. Overview of Information Processing

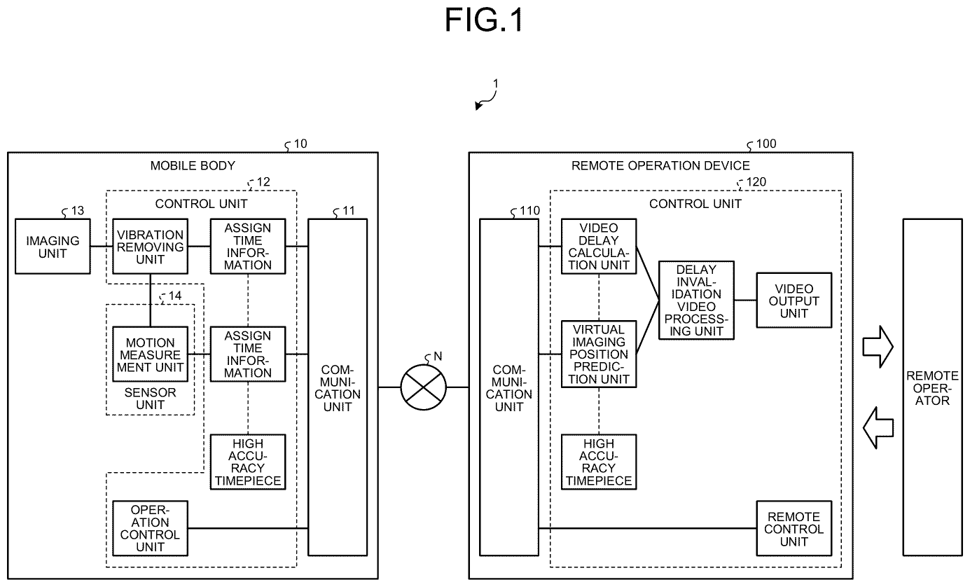

FIG. 1 is a diagram illustrating a configuration example of an information processing system 1 according to an embodiment of the present disclosure. Hereinafter, a case where the information processing device according to the embodiment of the present disclosure is a remote operation device 100 will be described. The information processing system 1 includes a mobile body 10 and the remote operation device 100. The mobile body 10 and the remote operation device 100 are connected to be able to perform wireless communication via a predetermined network N. Hereinafter, conceptually, an image includes both a video and a still image.

The mobile body 10 is an autonomous mobile device that can move by maneuvering of the remote operator. In the following description, a case where the mobile body 10 is a vehicle will be described, but the mobile body 10 is not limited to the vehicle. For example, the mobile body 10 may be a robot or a drone.

The mobile body 10 includes a communication unit 11, a control unit 12, an imaging unit 13, and a sensor unit 14.

The communication unit 11 is implemented by, for example, a network interface card (NIC) or the like. The communication unit 11 is wirelessly connected to the network N, and transmits and receives information to and from the remote operation device 100. For example, the communication unit 11 receives operation information regarding an operation of the mobile body 10 from the remote operation device 100. When the operation information is received, the communication unit 11 outputs the received operation information to an operation control unit of the control unit 12.

The control unit 12 is a controller and is implemented by, for example, a central processing unit (CPU), a micro processing unit (MPU), an application specific integrated circuit (ASIC), a field programmable gate array (FPGA), or the like executing various programs (corresponding to an example of an information processing program) stored in a storage device inside the mobile body 10 using a storage area such as a RAM as a work area. In the example illustrated in FIG. 1, the control unit 12 includes a vibration removing unit and the operation control unit.

The operation control unit of the control unit 12 receives operation information from the communication unit 11. When the operation information is received, the operation control unit of the control unit 12 controls the motion of the mobile body 10 according to the received operation information.

The control unit 12 acquires an image generated by the imaging unit 13 (hereinafter, referred to as a first image) and first time information at which the first image is generated from the imaging unit 13. The control unit 12 assigns the first time information at which the first image is generated to the first image generated by the imaging unit 13. The vibration removing unit of the control unit 12 removes vibration from the first image. The control unit 12 outputs, to the communication unit 11, the first image and the first time information at which the first image is generated. At a first frequency, the communication unit 11 transmits the first image and the first time information at which the first image is generated to the remote operation device 100.

The control unit 12 acquires the motion information generated by the sensor unit 14 and second time information at which the motion information is generated from the sensor unit 14. The control unit 12 assigns the second time information at which the motion information is generated to the motion information generated by the sensor unit 14. The control unit 12 outputs, to the communication unit 11, the motion information and the second time information at which the motion information is generated. At a second frequency higher than the first frequency, the communication unit 11 transmits the motion information and the second time information at which the motion information is generated to the remote operation device 100.

The imaging unit 13 implements a camera function of imaging a target. The imaging unit 13 includes, for example, an optical system such as a lens and an image sensor such as a charge coupled device (CCD) image sensor or a complementary metal oxide semiconductor (CMOS) sensor. The imaging unit 13 images an environment around the mobile body 10.

The sensor unit 14 is also referred to as a motion measurement unit. The sensor unit 14 includes various sensors mounted on or connected to the mobile body 10. The connection may be wired connection or wireless connection. For example, the sensors may be a detection device other than the mobile body 10 such as a wireless device. Specifically, the sensor unit 14 includes a speed sensor, an inertial sensor, and a steering angle sensor and generates motion information regarding the motion of the mobile body 10. For example, the sensor unit 14 generates information regarding temporal changes in a position and an attitude of the mobile body 10 as the motion information.

The remote operation device 100 includes a communication unit 110 and a control unit 120.

The communication unit 110 is implemented by, for example, an NIC or the like. The communication unit 110 is wirelessly connected to the network N, and transmits and receives information to and from the mobile body 10. For example, the communication unit 110 receives the operation information regarding the operation of the mobile body 10 input by the remote operator from the remote operation unit of the control unit 120. When the operation information is received, the communication unit 110 transmits the received operation information to the remote operation device 100.

The control unit 120 is a controller and is implemented by, for example, a CPU, an MPU, an ASIC, an FPGA, or the like executing various programs (corresponding to an example of an information processing program) stored in a storage device inside the remote operation device 100 using a storage area such as a RAM as a work area. In the example illustrated in FIG. 1, the control unit 120 includes a video delay calculation unit, a virtual imaging position prediction unit, a delay invalidation video processing unit, a video output unit, and a remote operation unit.

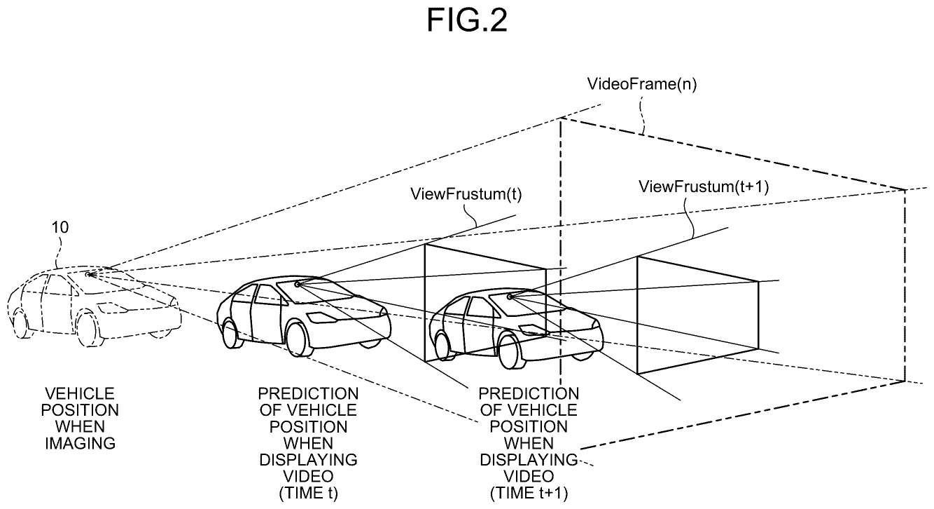

FIG. 2 is a diagram illustrating a relationship between a predicted position of the vehicle and the view frustum according to the embodiment of the present disclosure. The control unit 120 estimates mobile body position information regarding a position and an attitude of the mobile body 10 at a time at which the remote operator views a second image (a time at which the second image is displayed for the remote operator) based on the motion information. Specifically, the virtual imaging position prediction unit of the control unit 120 estimates the mobile body position information regarding the position and the attitude of the mobile body 10 at a time at which the video is displayed to the remote operator based on the position of the vehicle at a time at which the first image is captured. More specifically, the control unit 120 acquires previous motion information (latest motion information) among pieces of motion information acquired until a time point at which the mobile body position information is estimated. For example, the control unit 120 acquires information indicating a previous speed of the mobile body 10 as the previous motion information. The control unit 120 calculates a time difference between a time at which the first image is captured and a time at which the second image is displayed for the remote operator. Subsequently, the control unit 120 estimates a distance traveled by the mobile body 10 as the mobile body position information by multiplying the acquired speed of the mobile body 10 by the calculated time difference.

Based on the motion information, the control unit 120 estimates view frustum position information regarding the position and attitude of the view frustum at a time at which the operator views the second image. Specifically, based on the estimated mobile body position information, the virtual imaging position prediction unit of the control unit 120 estimates the view frustum position information regarding the position and the attitude of the view frustum at the time at which the video is displayed for the remote operator. Specifically, based on the estimated mobile body position information, the control unit 120 estimates the position and attitude of the view frustum corresponding to the position of the mobile body 10 indicated by the mobile body position information as the view frustum position information.

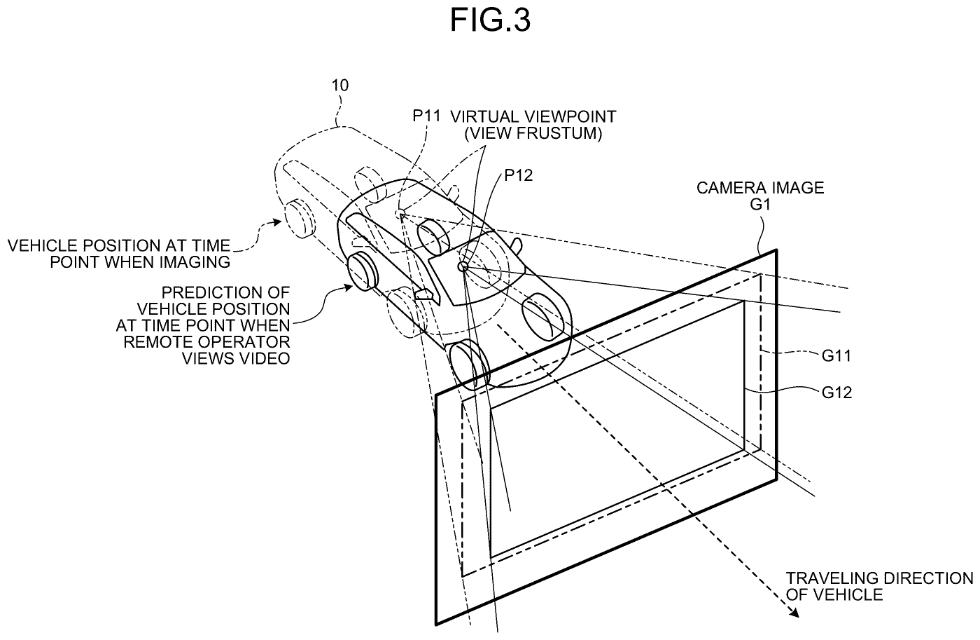

FIG. 3 is a diagram illustrating an example of object arrangement in a virtual space according to the embodiment of the present disclosure. FIG. 3 illustrates a case where a vehicle body travels straight forward in a traveling direction. The control unit 120 generates the second image viewed by the operator who remotely operates the mobile body based on the first image and the motion information. Specifically, the delay invalidation video processing unit of the control unit 120 generates a region (G12) as the second image in the first image (camera image G1) disposed in the virtual space illustrated in FIG. 3, the region (G12) disposed in the virtual space and intersecting a view frustum (a view frustum having a point P12 as a vertex) disposed at the position and the attitude indicated by the view frustum position information at the time at which the remote operator views the second image.

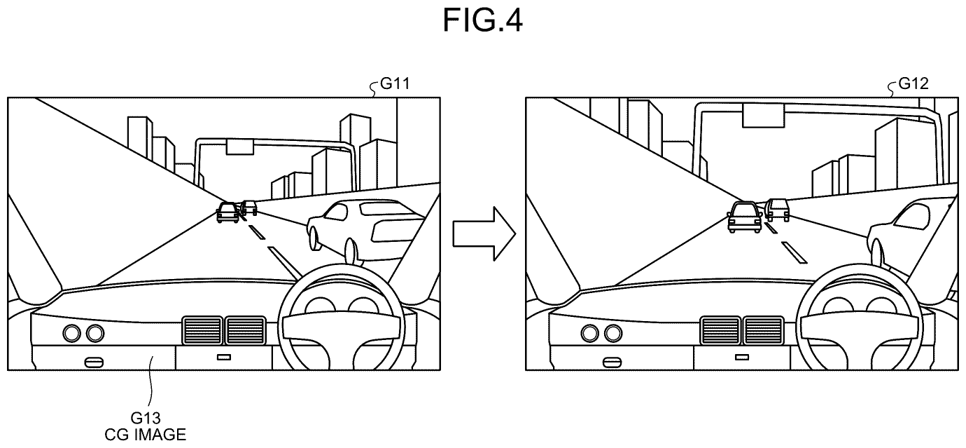

FIG. 4 is a diagram illustrating an example of the first image generated by an imaging unit of a vehicle traveling straight forward and the second image viewed by the remote operator according to the embodiment of the present disclosure. An image G11 illustrated on the left side of FIG. 4 corresponds to a region (G11) in the first image (camera image G1) disposed in the virtual space illustrated in FIG. 3, the region (G11) disposed in the virtual space and intersecting a view frustum (a view frustum having a point P11 as a vertex) disposed at the position of the vehicle at the time at which the first image is captured. On the other hand, an image G12 illustrated on the right side of FIG. 4 corresponds to a region (G12) in the first image (camera image G1) disposed in the virtual space illustrated in FIG. 3, the region (G12) disposed in the virtual space and intersecting the view frustum (the view frustum having the point P12 as a vertex) disposed at the position and attitude indicated by the view frustum position information at the time at which the remote operator views the second image. The video output unit of the control unit 120 enlarges an image of the region generated as the second image (G12) and displays the enlarged image on a screen viewed by the remote operator. As illustrated in FIG. 4, the control unit 120 performs control so that a CG image G13 corresponding to a dashboard of the mobile body is superimposed on the second image and displayed.

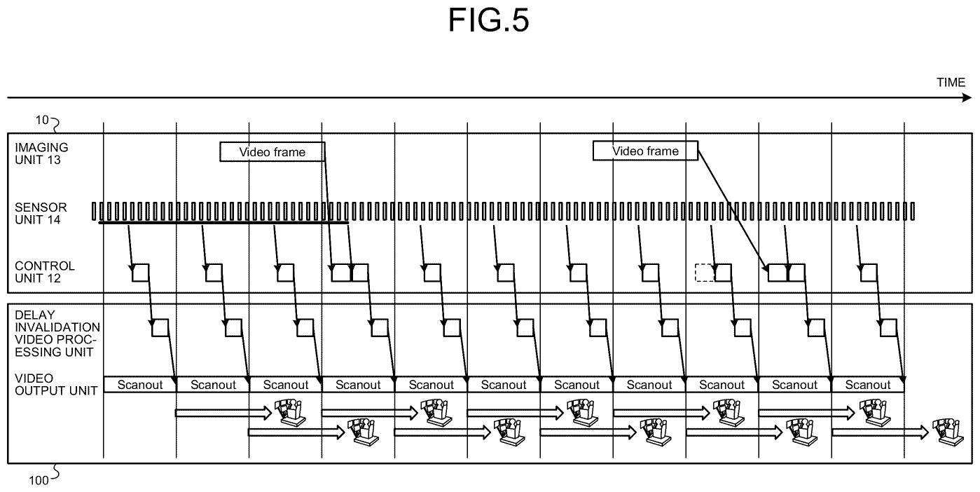

FIG. 5 is a diagram illustrating a relationship between an acquisition frequency of the first image and an acquisition frequency of the motion information according to the embodiment of the present disclosure. The control unit 120 receives, from the mobile body 10 via communication unit 110 at a first frequency, the first image generated by the imaging unit 13 mounted on the mobile body 10 (the video frame illustrated in FIG. 5) and the first time information at which the first image is generated. The control unit 120 receives, from the mobile body 10 via the communication unit 110 at a second frequency higher than the first frequency, the motion information regarding the motion of the mobile body generated by the sensor unit 14 mounted on the mobile body 10 and the second time information at which the motion information is generated. That is, the control unit 120 receives a set of the motion information and the second time information every second period shorter than a first period in which a set of the first image and the first time information is received. In the example illustrated in FIG. 5, the control unit 120 receives the set of the motion information and the second time information from the sensor unit 14 of the mobile body 10 every second period that is about ¼ of a time (first period) from reception of a set of one video frame (first image) and the first time information from the imaging unit 13 of the mobile body 10 to reception of a set of a subsequent video frame and the first time information. As illustrated in FIG. 5, the video delay calculation unit of the control unit 120 calculates a time from acquisition of the first image by the control unit 120 (for example, the delay invalidation video processing unit) to output of the second image by the video output unit of the control unit 120 as a video delay time.

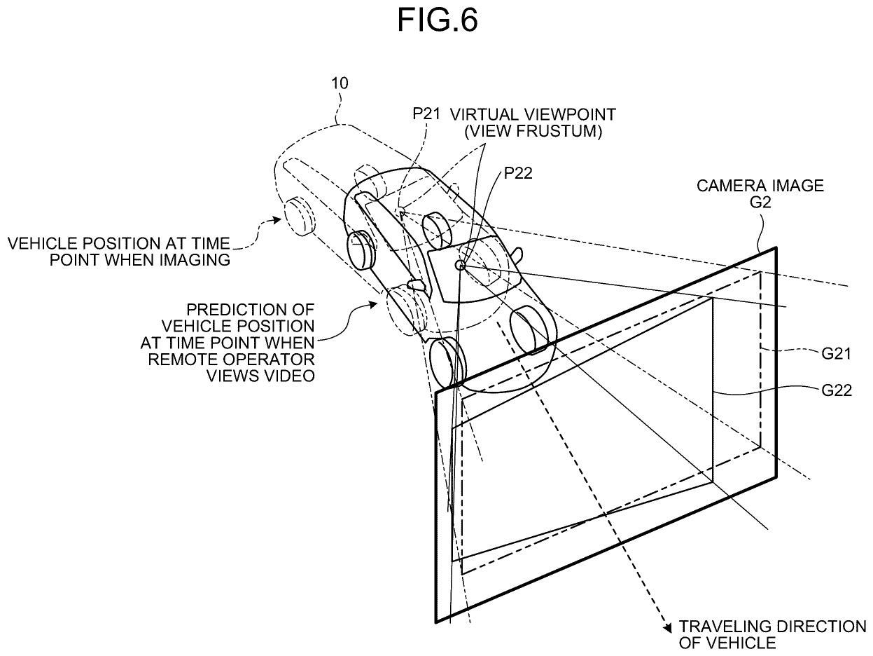

FIG. 6 is a diagram illustrating an example of the object arrangement in the virtual space according to the embodiment of the present disclosure. FIG. 6 is different from FIG. 3 in that the vehicle body performs a motion of turning right with respect to a traveling direction. In FIG. 6, the delay invalidation video processing unit of the control unit 120 generates a region (G22) as the second image in the first image (camera image G2) disposed in the virtual space illustrated in FIG. 6, the region (G22) disposed in the virtual space and intersecting the view frustum (a view frustum having a point P22 as a vertex) disposed at the position and the attitude indicated by the view frustum position information at the time at which the remote operator views the second image (a time at which the second image is displayed to the remote operator).

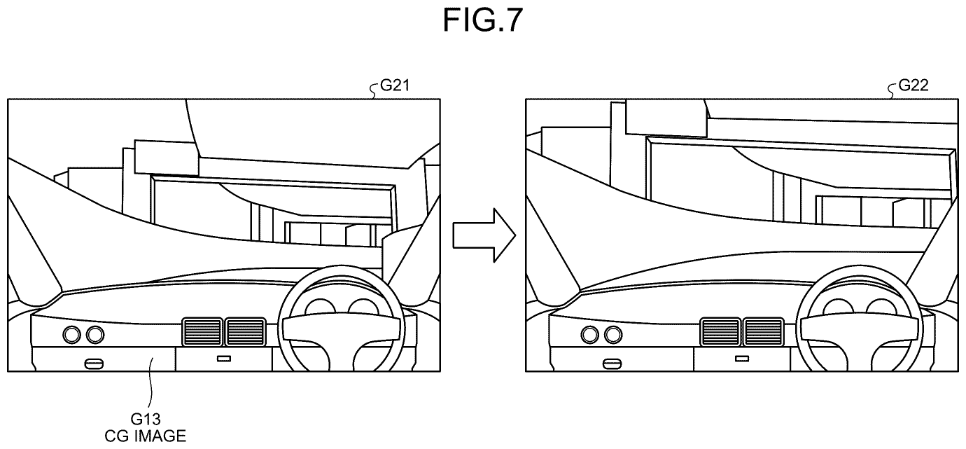

FIG. 7 is a diagram illustrating an example of the first image generated by the imaging unit of the vehicle turning a curve and the second image viewed by the remote operator according to the embodiment of the present disclosure. An image G21 illustrated on the left side of FIG. 7 corresponds to a region (G21) in the first image (camera image G2) disposed in the virtual space illustrated in FIG. 6, the region (G21) disposed in the virtual space and intersecting a view frustum (a view frustum having a point P21 as a vertex) disposed at the position of the vehicle at the time at which the first image is captured. On the other hand, an image G22 illustrated on the right side of FIG. 7 corresponds to a region (G22) in the first image (camera image G2) disposed in the virtual space illustrated in FIG. 6, the region (G22) disposed in the virtual space and intersecting the view frustum (the view frustum having the point P22 as a vertex) disposed at the position and attitude indicated by the view frustum position information at the time at which the remote operator views the second image. The video output unit of the control unit 120 enlarges an image of the region generated as the second image (G22) and displays the enlarged image on the screen viewed by the remote operator.

Although not illustrated, the remote operation device 100 may include a storage unit. The storage unit is implemented by, for example, a semiconductor memory element such as a random access memory (RA) or a flash memory, or a storage device such as a hard disk or an optical disc. For example, the storage unit stores various programs and data used by each unit of the remote operation device 100.

### 3. Information Processing Procedure

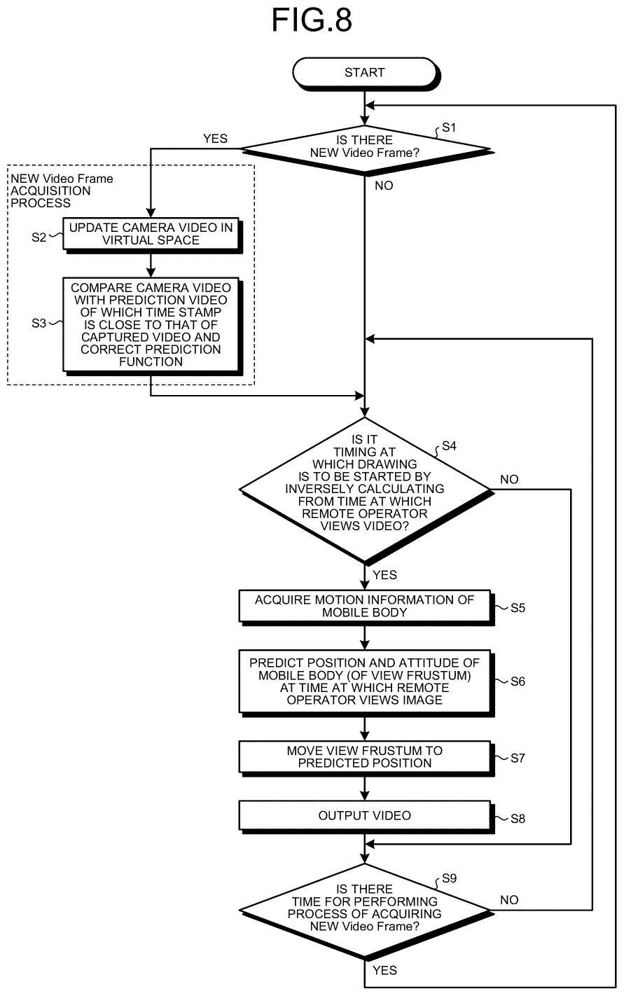

FIG. 8 is a flowchart illustrating an information processing procedure by the remote operation device according to the embodiment of the present disclosure. The remote operation device 100 determines whether a new video frame exists (step S1). When the remote operation device 100 determines that a new video frame exists (step S1; Yes), a process of acquiring the new video frame is performed. Specifically, the remote operation device 100 updates the camera video disposed in the virtual space (step S2). Subsequently, the remote operation device 100 compares the camera video with a prediction video of which a time stamp is close to that of the captured video, and corrects a prediction function (step S3). Subsequently, the remote operation device 100 determines whether it is a timing at which drawing is to be started by inversely calculating from a time at which the remote operator views the video (step S4). Conversely, when the remote operation device 100 does not determine that a new video frame exists (step S1; No), it is determined whether it is a timing at which the drawing is to be started by inversely calculating from the time at which the remote operator views the image (step S4).

When the remote operation device 100 determines that it is a timing at which the drawing is to be started (step S4; Yes), the motion information of the mobile body 10 is acquired (step S5). Subsequently, the remote operation device 100 predicts a position and an attitude of the mobile body (of the view frustum) at the time at which the remote operator views the image (step S6). Subsequently, the remote operation device 100 moves the view frustum to the predicted position (step S7). Subsequently, the remote operation device 100 outputs the video of the region intersecting the view frustum in the camera video disposed in the virtual space (step S8). Subsequently, the remote operation device 100 determines whether there is time for performing the process of acquiring a new video frame (step S9). Conversely, when the remote operation device 100 does not determine that it is the timing at which the drawing is to be started (step S4; No), it is determined whether there is time for performing the process of acquiring the new video frame (step S9).

When the remote operation device 100 does not determine that there is time for performing the process of acquiring the new video frame (step S9; No), it is determined whether it is a timing at which the drawing is to be started by inversely calculating from the time at which the remote operator views the image (step S4). Conversely, when the remote operation device 100 determines that there is time for performing the process of acquiring the new video frame (step S9; Yes), it is determined whether a new video frame exists (step S1).

### 4. Modifications

The remote operation device 100 according to the above-described embodiment may be implemented in various different modes other than the above-described embodiment. Accordingly, another embodiment of the remote operation device 100 will be described below. The same portions as those in the embodiment are denoted by the same reference numerals, and the description thereof will be omitted.

### 4-1. Method without Using View Frustum

In the above-described embodiment, the case where the remote operation device 100 estimates the view frustum position information regarding the position and the attitude of the view frustum at the time at which the operator views the second image and generates the second image based on the estimated position and attitude of the view frustum is described, but the remote operation device 100 may generate the second image without using the view frustum. For example, based on the motion information, the control unit 120 estimates a distance by which the vehicle travels in the traveling direction at a predetermined time. Subsequently, the control unit 120 may generate a region in the first image reduced according to the distance by which the vehicle travels as the second image.

### 4-2. Countermeasures Against Vibration of Camera

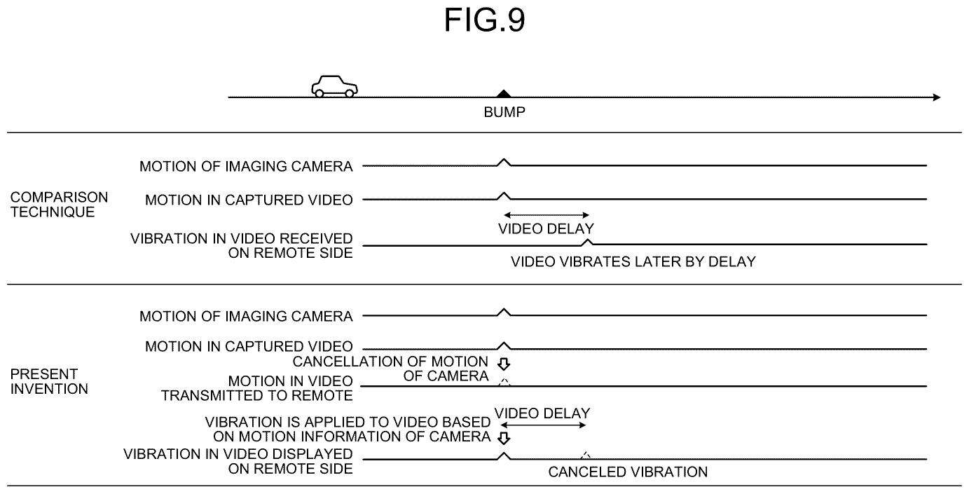

FIG. 9 is a diagram illustrating countermeasures against vibration of a camera according to a modification of the embodiment of the present disclosure. In a comparison technique illustrated in FIG. 9, when the vehicle bumps (moves in the vertical direction) on a road, a camera mounted on the vehicle also bumps, and thus an image captured by the camera has vibration in the vertical direction. Since a video viewed by the remote operator arrives late, the remote operator views the video vibrated later by a delay corresponding to the delay of the video.

On the other hand, the control unit 120 according to the invention of the present application corrects blurring of the first image occurring due to a motion of the mobile body in the vertical direction. Specifically, the control unit 120 corrects the first image so that the vibration in the first image is canceled. The control unit 120 applies processing corresponding to vibration occurring by a motion of the mobile body in the vertical direction to the second image viewed by the operator at a time at which the mobile body moves in the vertical direction. Specifically, the control unit 120 applies processing corresponding to vibration equivalent to vibration in the first image to the second image viewed by the operator at the time at which the mobile body moves in the vertical direction based on the motion information.

### 4-3. Resolution of Second Image

For example, as illustrated in FIG. 3, when the vehicle travels straight forward in the traveling direction, the view frustum approaches the first image disposed in the virtual space, and thus an area of the image cut out by the view frustum decreases over time. Therefore, since the second image displayed for the remote operator is generated by enlarging an image with a small area, pixels become rough over time. Accordingly, the control unit 120 generates each of a plurality of second images so that the resolution of each of the plurality of second images generated from one first image falls within a predetermined range. For example, the control unit 120 calculates a resolution of the last generated second image among the plurality of second images generated from one first image. Subsequently, the control unit 120 generates a first generated second image by roughening the resolution of the first generated second image so that a difference between the resolution of the first generated second image and the resolution of the last generated second image falls within a predetermined range. Similarly, the control unit 120 generates second and subsequent generated second images by roughening the resolutions of the second and subsequent second images so that a difference between the resolutions of the second and subsequent second images and the resolution of the last generated second image falls within a predetermined range.

### 4-4. Display Mode Indicating that Second Image is Displayed

When the second image is displayed on the screen, the control unit 120 performs control so that the second image is displayed on the screen in a display mode in which the operator can visually recognize that the second image is displayed. For example, when the second image is displayed on the screen, the control unit 120 displays the second image in the display mode in which the operator can visually recognize that the second image is displayed by surrounding the second image with a red frame or the like.

### 4-5. Object Approach Notification

When the sensor unit 14 detects an object located within a predetermined range from the mobile body, the control unit 120 performs control so that information notifying the operator that an object is detected is displayed on the video output unit. For example, the control unit 120 performs control so that a region where the object appeared is visually emphasized and displayed on the video output unit.

Specifically, the sensor unit 14 includes a ranging sensor. For example, the sensor unit 14 may include a radio detection and ranging (RADAR), a light detection and ranging (LiDAR), an ultrasonic sensor, a stereo camera, or the like as the ranging sensor.

### 5. Effects

As described above, an information processing device (the remote operation device 100 in the embodiment) according to the embodiment of the present disclosure includes a control unit (the control unit 120 in the embodiment). The control unit receives, at a first frequency, a first image generated by an imaging unit (the imaging unit 13 in the embodiment) mounted on a mobile body (the mobile body 10 in the embodiment) and first time information at which the first image is generated, receives, at a second frequency higher than the first frequency, motion information regarding a motion of the mobile body generated by a sensor unit (the sensor unit 14 in the embodiment) mounted on the mobile body and second time information at which the motion information is generated, and generates a second image based on the first image and the motion information. For example, the second image is viewed by an operator who remotely operates the mobile body.

Accordingly, the information processing device can present an image in which an apparent delay time is invalidated to the remote operator. Accordingly, the information processing device can enable an operator to perform an operation without feeling uncomfortable or anxious and without perceiving delay of the video even when the video is delayed. The information processing device acquires the motion information of the mobile body at a frequency higher than a frequency at which the camera video is acquired. Accordingly, the information processing device can complement the video even between frames of the camera video, and thus a problem due to a low frame rate can be solved at the same time. In actual communication, since a communication rate and communication delay are always changed, a frame interval of the camera video is also always changed. The information processing device can take flexible countermeasures against such change in the frame interval of the camera video, and can display an image with reduced discomfort even if the camera video is suddenly delayed or is lacking. Accordingly, the information processing device can improve usability in a remote operation of a mobile body.

The control unit estimates mobile body position information regarding a position and an attitude of the mobile body at a time at which the operator views the second image based on the motion information and generates the second image based on the first image and the mobile body position information.

Accordingly, the information processing device can present an image in which an apparent delay time is invalidated to the remote operator.

The control unit estimates view frustum position information regarding a position and an attitude of a view frustum at the time at which the operator views the second image based on the motion information, and generates a region as the second image in the first image disposed in the virtual space, the region disposed in the virtual space and intersecting the view frustum disposed at the position and the attitude indicated by the view frustum position information.

Accordingly, the information processing device can present an image in which an apparent delay time is invalidated to the remote operator.

The control unit generates each of a plurality of second images so that a resolution of each of the plurality of second images generated from one first image falls within a predetermined range.

Accordingly, the information processing device can present an image in which an apparent delay time is invalidated to the remote operator without causing the remote operator to feel the change.

The control unit corrects blurring of the first image caused by the motion of the mobile body in a vertical direction, and applies processing corresponding to vibration caused by the motion of the mobile body in the vertical direction to the second image viewed by the operator at the time at which the mobile body moves in the vertical direction.

Accordingly, the information processing device can present an image in which a delay time at the time at which the mobile body moves in the vertical direction is invalidated to the remote operator.

The information processing device further includes an output unit that displays the second image. When the second image is displayed on the output unit, the control unit performs control so that the second image is displayed on the output unit in a display mode in which the operator is able to visually recognize that the second image is displayed.

Accordingly, the information processing device alerts the remote operator that attention is necessary because of a difference from the real-time on-site image.

When the sensor unit detects an object located within a predetermined range from the mobile body, the control unit performs control so that information notifying the operator that an object is detected is displayed on the output unit.

Accordingly, even when the image in which the apparent delay time is invalidated is viewed, the information processing device can notify the remote operator of, for example, an accident at the site that occurred in real time (such as an animal running in) or the like.

The control unit performs control so that a region where the object appeared is visually emphasized and displayed on the output unit.

Accordingly, even when the image in which the apparent delay time is invalidated is viewed, the information processing device can more effectively notify the remote operator of, for example, an accident at the site that occurred in real time (such as an animal running in) or the like.

The control unit performs control so that an image corresponding to a dashboard of the mobile body is superimposed on the second image and displayed.

Accordingly, the information processing device can assist the remote operator to perform the remote operation in a state close to a state where the remote operator actually operates the mobile body by using the image corresponding to the dashboard of the mobile body as a clue.

### 6. Hardware Configuration

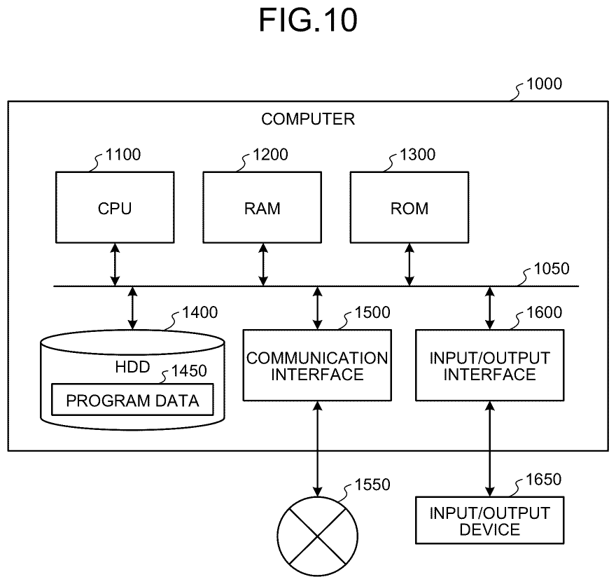

An information device such as the remote operation device 100 according to the above-described embodiment is reproduced by, for example, a computer 1000 that has a configuration illustrated in FIG. 10. FIG. 10 is a hardware configuration diagram illustrating an example of the computer 1000 that implements functions of the information processing device such as the remote operation device 100. Hereinafter, the remote operation device 100 according to the embodiment will be described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400 and controls each unit. For example, the CPU 1100 loads a program stored in the ROM 1300 or the HDD 1400 on the RAM 1200 and executes processes corresponding to various programs.

The ROM 1300 stores a boot program such as a basic input output system (BIOS) executed by the CPU 1100 when the computer 1000 starts, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records a program according to the present disclosure which is an example of program data 1450.

The communication interface 1500 is an interface for connection of the computer 1000 to an external network 1550 (for example, the Internet). For example, the CPU 1100 receives data from another device or transmits data generated by the CPU 1100 to another device via the communication interface 1500.

The input/output interface 1600 is an interface for connection of an input/output device 1650 and the computer 1000. For example, the CPU 1100 receives data from an input device such as a keyboard and a mouse via the input/output interface 1600. The CPU 1100 transmits data to an output device such as a display, a speaker, or a printer via the input/output interface 1600. The input/output interface 1600 may function as a medium interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the remote operation device 100 according to the embodiment, the CPU 1100 of the computer 1000 reproduces functions of the control unit 120 and the like by executing a program loaded on the RAM 1200. The HDD 1400 stores various types of data and a program according to the present disclosure. The CPU 1100 reads the program data 1450 from the HDD 1400 and executes the program data, but as another example, the programs may be acquired from another device via the external network 1550.

The effects described in the present specification are merely illustrative or exemplary, and are not limited. That is, the technique according to the present disclosure can exhibit other effects obvious to those skilled in the art from the description of the present specification in addition to or instead of the above effects.

The present technique can also have the following configurations.

(1)

An information processing device comprising
a control unit configured to
receive, at a first frequency, a first image generated by an imaging unit mounted on a mobile body and first time information at which the first image is generated,
receive, at a second frequency higher than the first frequency, motion information regarding a motion of the mobile body generated by a sensor unit mounted on the mobile body and second time information at which the motion information is generated, and
generate a second image based on the first image and the motion information.
   (2)

The information processing device according to (1), wherein
the second image is viewed by an operator who remotely operates the mobile body.
   (3)

The information processing device according to (2), wherein
the control unit
estimates mobile body position information regarding a position and an attitude of the mobile body at a time at which the operator views the second image based on the motion information, and
generates the second image based on the first image and the mobile body position information.
   (4)

The information processing device according to (3), wherein
the control unit
estimates view frustum position information regarding a position and an attitude of a view frustum at a time at which the operator views the second image based on the motion information, and
generates a region as the second image in the first image disposed in a virtual space, the region disposed in the virtual space and intersecting the view frustum disposed at the position and attitude indicated by the view frustum position information.
   (5)

The information processing device according to any one of (1) to (4), wherein
the control unit
generates each of a plurality of the second images generated from one first image so that a resolution of each of the plurality of second images falls within a predetermined range.
   (6)

The information processing device according to any one of (1) to (5), wherein
the control unit
corrects blurring of the first image caused by a motion of the mobile body in a vertical direction, and
applies processing corresponding to vibration caused by the motion of the mobile body in the vertical direction to the second image.
   (7)

The information processing device according to any one of (2) to (6), further comprising
an output unit configured to display the second image, wherein
the control unit,
when the second image is displayed on the output unit, performs control so that the second image is displayed on the output unit in a display mode in which the operator is able to visually recognize that the second image is displayed.
   (8)

The information processing device according to any one of (2) to (7), further comprising
an output unit configured to display the second image, wherein
the control unit,
when the sensor unit detects an object located within a predetermined range from the mobile body, performs control so that information notifying the operator that the object is detected is displayed on the output unit.
   (9)

The information processing device according to (8), wherein
the control unit
performs control so that a region where the object appeared is visually emphasized and displayed on the output unit.
   (10)

The information processing device according to any one of (1) to (9), wherein
the control unit
performs control so that an image corresponding to a dashboard of the mobile body is superimposed on the second image and displayed.
   (11)

An information processing method executed by an information processing device, the method comprising:
receiving, at a first frequency, a first image generated by an imaging unit mounted on a mobile body and first time information at which the first image is generated;
receiving, at a second frequency higher than the first frequency, motion information regarding a motion of the mobile body generated by a sensor unit mounted on the mobile body and second time information at which the motion information is generated; and
generating a second image based on the first image and the motion information.
   (12)

An information processing system comprising: a mobile body; and an information processing device, wherein
the information processing device includes
a control unit configured to
receive, at a first frequency, a first image generated by an imaging unit mounted on the mobile body and first time information at which the first image is generated,
receive, at a second frequency higher than the first frequency, motion information regarding a motion of the mobile body generated by a sensor unit mounted on the mobile body and second time information at which the motion information is generated, and
generate a second image based on the first image and the motion information.

### REFERENCE SIGNS LIST

1 INFORMATION PROCESSING SYSTEM
10 MOBILE BODY
11 COMMUNICATION UNIT
12 CONTROL UNIT
13 IMAGING UNIT
14 SENSOR UNIT
100 REMOTE OPERATION DEVICE
110 COMMUNICATION UNIT
120 CONTROL UNIT

1. An information processing device comprising
a control unit configured to
receive, at a first frequency, a first image generated by an imaging unit mounted on a mobile body and first time information at which the first image is generated,
receive, at a second frequency higher than the first frequency, motion information regarding a motion of the mobile body generated by a sensor unit mounted on the mobile body and second time information at which the motion information is generated, and
generate a second image based on the first image and the motion information.

2. The information processing device according to claim 1, wherein
the second image is viewed by an operator who remotely operates the mobile body.

3. The information processing device according to claim 2, wherein
the control unit
estimates mobile body position information regarding a position and an attitude of the mobile body at a time at which the operator views the second image based on the motion information, and
generates the second image based on the first image and the mobile body position information.

4. The information processing device according to claim 3, wherein
the control unit
estimates view frustum position information regarding a position and an attitude of a view frustum at a time at which the operator views the second image based on the motion information, and
generates a region as the second image in the first image disposed in a virtual space, the region disposed in the virtual space and intersecting the view frustum disposed at the position and attitude indicated by the view frustum position information.

5. The information processing device according to claim 1, wherein
the control unit
generates each of a plurality of the second images generated from one first image so that a resolution of each of the plurality of second images falls within a predetermined range.

6. The information processing device according to claim 1, wherein
the control unit
corrects blurring of the first image caused by a motion of the mobile body in a vertical direction, and
applies processing corresponding to vibration caused by the motion of the mobile body in the vertical direction to the second image.

7. The information processing device according to claim 2, further comprising
an output unit configured to display the second image, wherein
the control unit,
when the second image is displayed on the output unit, performs control so that the second image is displayed on the output unit in a display mode in which the operator is able to visually recognize that the second image is displayed.

8. The information processing device according to claim 2, further comprising
an output unit configured to display the second image, wherein
the control unit,
when the sensor unit detects an object located within a predetermined range from the mobile body, performs control so that information notifying the operator that the object is detected is displayed on the output unit.

9. The information processing device according to claim 8, wherein
the control unit
performs control so that a region where the object appeared is visually emphasized and displayed on the output unit.

10. The information processing device according to claim 1, wherein
the control unit
performs control so that an image corresponding to a dashboard of the mobile body is superimposed on the second image and displayed.

11. An information processing method executed by an information processing device, the method comprising:
receiving, at a first frequency, a first image generated by an imaging unit mounted on a mobile body and first time information at which the first image is generated;
receiving, at a second frequency higher than the first frequency, motion information regarding a motion of the mobile body generated by a sensor unit mounted on the mobile body and second time information at which the motion information is generated; and
generating a second image based on the first image and the motion information.

12. An information processing system comprising: a mobile body; and an information processing device, wherein
the information processing device includes
a control unit configured to
receive, at a first frequency, a first image generated by an imaging unit mounted on the mobile body and first time information at which the first image is generated,
receive, at a second frequency higher than the first frequency, motion information regarding a motion of the mobile body generated by a sensor unit mounted on the mobile body and second time information at which the motion information is generated, and
generate a second image based on the first image and the motion information.
